(19) United States
(12) Patent Application Publication
(10) Pub. No.: US 2023/0373364 A1
(43) Pub. Date: Nov. 23, 2023

(54) ADJUSTABLE VEHICULAR SAFETY SEAT

(71) Applicant: Thomas Jefferson University, Philadelphia, PA (US)

(72) Inventors: Cole Jackson Miller, Philadelphia, PA (US); Isaac Michael Savinese, Ridley Park, PA (US); Jasmine Phun, Philadelphia, PA (US); Yajnesh Vendanaparti, Downingtown, PA (US); Galen Ogg, Philadelphia, PA (US); Frank Porras-Gonzalez, Philadelphia, PA (US)

(21) Appl. No.: 18/030,887

(22) PCT Filed: Oct. 11, 2021
(86) PCT No.: PCT/US2021/071811

§ 371 Date: Apr. 7, 2023

Related U.S. Application Data
(60) Provisional application No. 63/091,104, filed on Oct. 13, 2020.

(51) Int. Cl. B60N 2/28

(52) U.S. Cl. CPC B60N 2/286; B60N 2/2872; B60N 2/2884

(57) ABSTRACT

Adjustable vehicular safety seats are described herein. In one aspect, a child vehicular safety seat can include a seat back adapted and configured to support a child's back; and a pommel extending substantially perpendicular from adjacent to the seat back, such that the child's perineum is supported by the pommel while the child's legs hang on either side of the pommel. In one embodiment, the pommel is fixedly attached to the seat back. In another embodiment, the child vehicular safety seat can further include a pair of adjustable supports, one on each side of the pommel. In some cases, the pair of adjustable supports are movable substantially parallel to an axis defined by the pommel. In some cases, the pair of adjustable supports are movable independently. In some cases, the pair of adjustable supports are movable in tandem.

### CROSS-REFERENCE TO RELATED APPLICATION

This application claims the benefit of priority under 35 U.S.C. § 119(e) to U.S. Provisional Patent Application Ser. No. 63/091,104, filed Oct. 13, 2020. The entire content of this application is hereby incorporated by reference herein.

### BACKGROUND OF THE INVENTION

Pediatric patients with femur fractures and severe hip dysplasia typically undergo surgery or reduction procedures and require Spica casts to stabilize their hips post-operatively. Spica casts immobilize the hip in a flexed and abducted position and the knees in a flexed position to facilitate proper healing of the hip joint and the surrounding bones and tendons. However, due to the casts' wide hip angle and straightened back, these children cannot fit into most traditional car seats. This places a significant burden on the patients' families, not only during the hospital discharge process, but also during their day-to-day travel.

Spica casts typically begin near the chest and extend down to either the feet or knees and the casts can immobilize either both legs or only one. There is a wide variety in the forms of Spica casts because how the child is casted depends on the type and location of the orthopedic injury as well as their size and body type. Most car seat options for these patients fail to accommodate the many casting forms that are possible. Commonly, children in Spica casts are shifted forwards in current car seat options so that their immobile, flexed knees can hang over the edge of the seat. However, this leaves a large space between the back of the cast and the seat back. Additionally, this positioning forces the head to be flexed forward, compromising the child's airway. This can be addressed by placing additional padding under the child to fill in the gap behind them and straighten the angle between their thoracic and cervical spine. However, most car seat companies prohibit the use of additional padding because the additional padding and car seat combination has not been crash-tested and may pose safety risks for the child.

### SUMMARY

Adjustable vehicular safety seats are described herein. In one aspect, a child vehicular safety seat can include a seat back adapted and configured to support a child's back; and a pommel extending substantially perpendicular from adjacent to the seat back, such that the child's perineum is supported by the pommel while the child's legs hang on either side of the pommel.

This aspect can include a variety of embodiments. In one embodiment, the pommel is fixedly attached to the seat back. In another embodiment, the child vehicular safety seat can further include a pair of adjustable supports, one on each side of the pommel. In some cases, the pair of adjustable supports are movable substantially parallel to an axis defined by the pommel. In some cases, the pair of adjustable supports are movable independently. In some cases, the pair of adjustable supports are movable in tandem.

In another embodiment, the child vehicular safety seat can further include a pair of side-protection wings, each of the pair of side-protection wings coupled to an opposing side of the seat back. In some cases, the pair of side-protection wings is rotatably coupled to the seat back.

### BRIEF DESCRIPTION OF THE DRAWINGS

For a fuller understanding of the nature and desired objects of the present invention, reference is made to the following detailed description taken in conjunction with the accompanying drawing figures wherein like reference characters denote corresponding parts throughout the several views.

FIG. 1 is a perspective view of an adjustable vehicular safety seat according to an embodiment of the claimed invention.

FIG. 2 is a perspective view of a pommel base and support pads of an adjustable vehicular safety seat according to an embodiment of the claimed invention.

FIG. 3 is a superior view of the pommel base and support pads of an adjustable vehicular safety seat according to an embodiment of the claimed invention.

FIG. 4 is an anterior view of the pommel base and support pads of an adjustable vehicular safety seat according to an embodiment of the claimed invention.

FIG. 5 is a perspective view of an adjustable vehicular safety seat according to an embodiment of the claimed invention.

FIG. 6 is a superolateral view of the pivoting mechanism for the side impact protection wings of an adjustable vehicular safety seat according to an embodiment of the claimed invention.

FIG. 7 is a inferolateral view of the pivoting mechanism for the side impact protection wings of an adjustable vehicular safety seat according to an embodiment of the claimed invention.

FIGS. 8-11 depict various perspective views of an adjustable vehicular safety seat, according to embodiments of the claimed invention.

### DEFINITIONS

The instant invention is most clearly understood with reference to the following definitions.

As used herein, the singular form “a,” “an,” and “the” include plural references unless the context clearly dictates otherwise.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from context, all numerical values provided herein are modified by the term about.

As used in the specification and claims, the terms “comprises,” “comprising,” “containing,” “having,” and the like can have the meaning ascribed to them in U.S. patent law and can mean “includes,” “including,” and the like.

Unless specifically stated or obvious from context, the term “or,” as used herein, is understood to be inclusive.

Ranges provided herein are understood to be shorthand for all of the values within the range. For example, a range of 1 to 50 is understood to include any number, combination of numbers, or sub-range from the group consisting 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 (as well as fractions thereof unless the context clearly dictates otherwise).

### DETAILED DESCRIPTION OF THE INVENTION

The present disclosure relates to an adaptable vehicular safety seat that is adaptable for pediatric patients immobilized in any variation or size of Spica cast. The modular, adjustable car seat can position the occupant in an upright position by allowing the casted legs to straddle the pommel-shaped seat base. The straddling position can avoid the need to shift the child forward in the seat, thereby preventing the formation of a gap behind the patient's back and excessive flexion of the patient's cervical spine. The safety seat can include a pommel-shaped base, an extendable seat back, and extendable support padding to adjust to various Spica casting configurations.

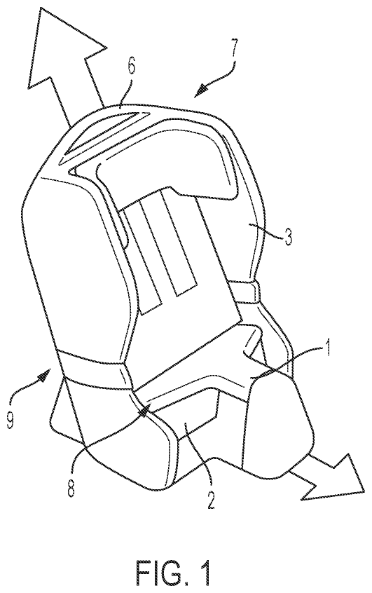

FIG. 1 depicts an adjustable vehicular safety seat 7 according to an embodiment of the claimed invention. The safety seat 7 can include a seat back 9 and a seat bottom 8. The safety seat includes a pommel-shaped seat base 1, a pair of extendable support pads 2, an extendable seat back 6, and side protection wings 3.

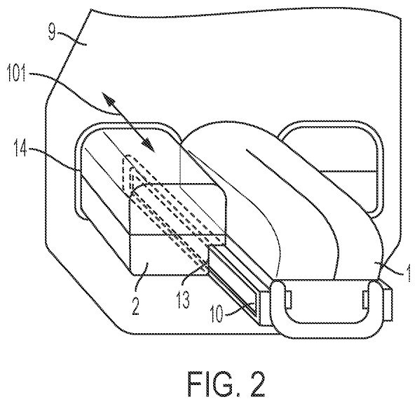

As shown in FIG. 2, the pommel-shaped seat base 1 can extend in the horizontal direction, distally away from the seat back 9. The support pads 2 can include a slide track 13 molded into its flank, which can allow the supports pads 2 to slide forward and backward (e.g., along directions 101) along the complementary drawer slide 10 on the pommel base 1. As the support pads 2 retract into the seat back 9, the support pads 2 can pass through slots 14 in the seat back 9.

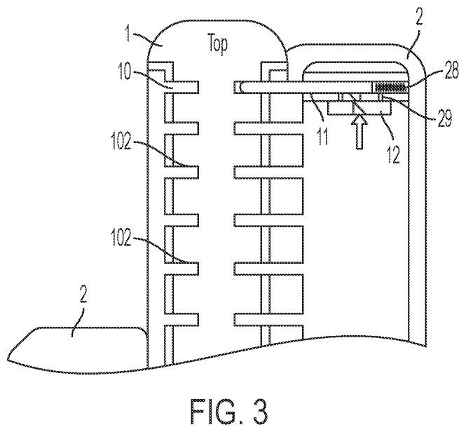

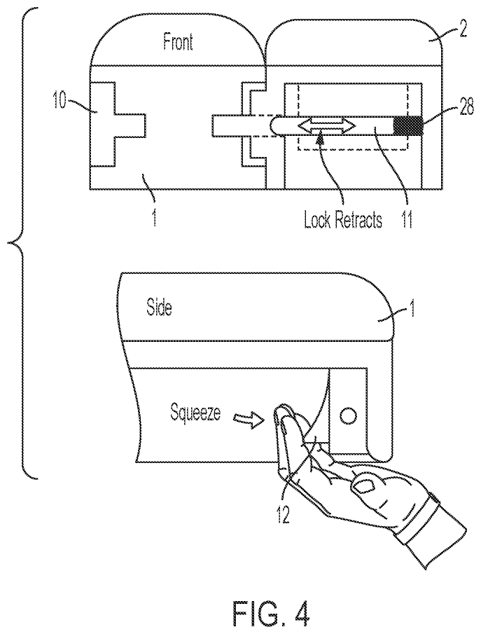

FIGS. 3 and 4 show the components of the locking mechanism that prevents free movement of the support pads 2 during use. The pommel base's 1 slide track 10 can contain several 102 notches along its length. The locking pin 11 attached to the anterior portion of the inner flank of the support pads 2 can insert into the notches 102 on the slide track 10. A button 12 on the underside of the support pad 2 can retract the locking pin 11 out of the notches 102. A spring 28 on the end of the locking pin 11 can secure locking pin 11 in a locked (extended) position when the button 12 is not depressed. A pair of springs 29 can secure the button 12 in a disengaged position when the button 12 is not being pressed. When the button 12 is pressed, the triangular portion can depress forward until the triangular portion contacts a triangular portion of the locking pin 11. When the triangular portion come into contact, the locking pin 11 can be forced to slide in the horizontal plane to allow the triangular portion of the button 12 to depress fully. The locking pin 11 can then retract from the notches 102 in the slide track 10. When the button 12 is pressed, the support pad 2 can freely slide in the forward and backward direction along the length of the slide track 10.

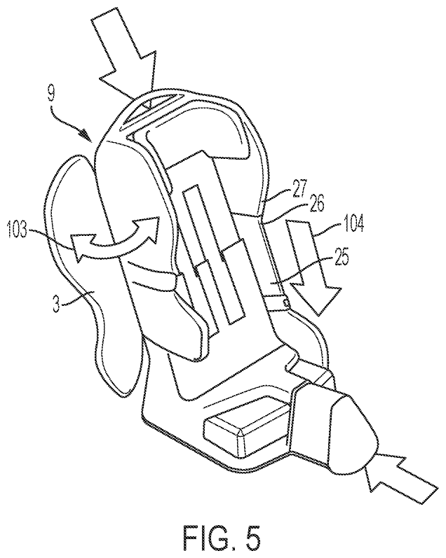

FIG. 5 illustrates adjustable side-protection wings 3, and their various configurations, for an adjustable vehicular safety seat according to an embodiment of the claimed invention. The side-protection wings 3 can pivot to either side and can rotate around the axis as protection wing shares with the seat back 9 (e.g., in the directions 103). The side-protection wings 3 can also extend in the vertical direction by sliding downwards (e.g., along direction 104) along the extending portion 25 that inserts into the upper portion of the wing 3. The extending portion 25 can include one or more notches 26 that can secure the position of the wing 3. A button 27 on the upper portion of the wings 3 can retract a locking pin from the notches 26 when depressed. When the button 27 is released, the locking pins can extend back into the notches 26 in the side of the extending portion 25.

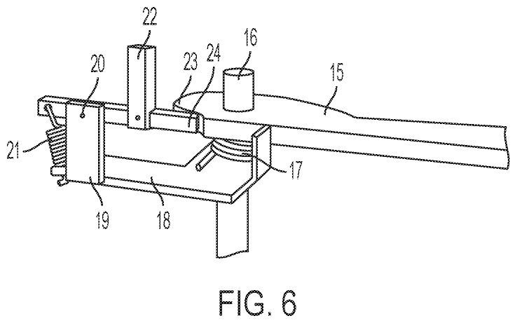

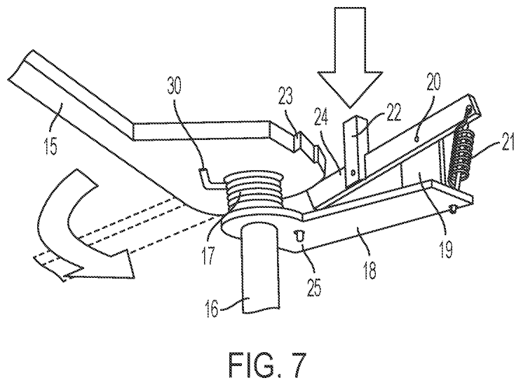

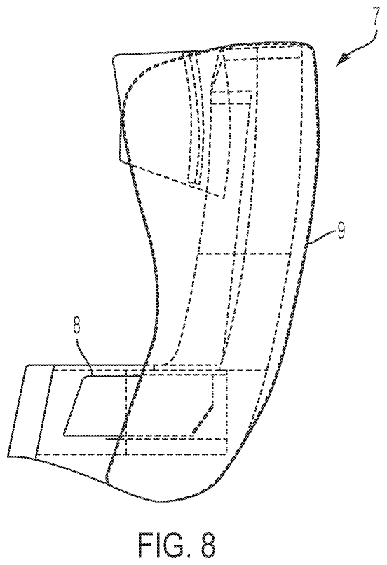

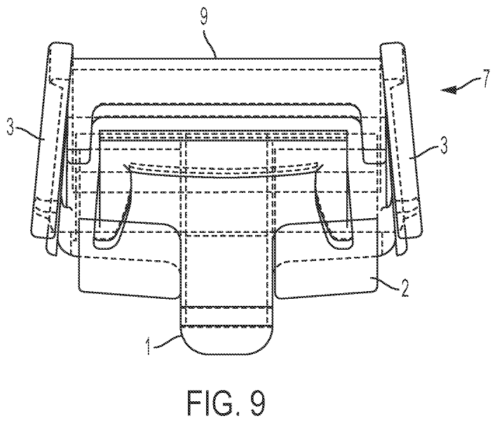

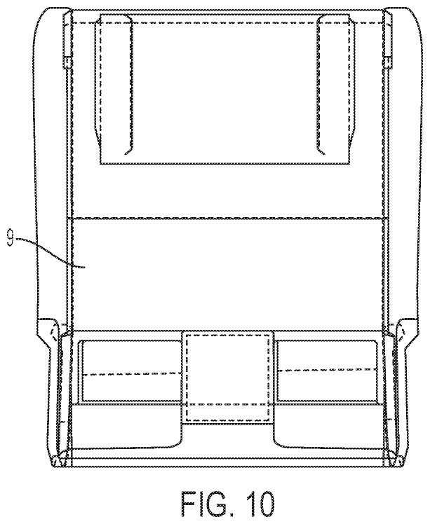

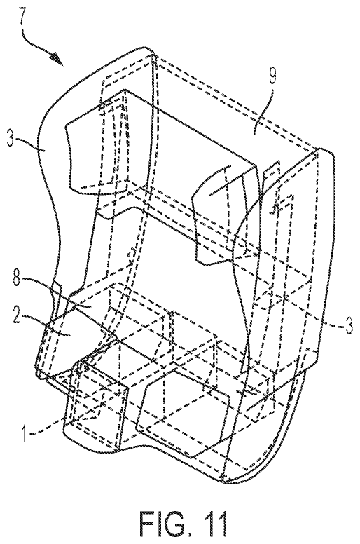

FIGS. 6 and 7 illustrate perspective views of the components of the pivoting mechanism of the side impact protection wings 3 in several different configurations. The ratcheting system can include a bar 16 attached perpendicularly to a cam 15 with one or more ratchet points 23, and a maneuverable pawl 24. The cam 15 can be held in an inward direction by a spring 17 attached to the cam 15 through a small orifice 30. The spring 17 can wrap around the perpendicular bar and can attach to a stationary plate 18 below the cam 15. The maneuverable pawl 24 can attach to a portion 19 of the stationary plate that extends perpendicular to the length of the stationary plate 18 via a pivot point 20. The pawl 24 can extend past the pivot point 20 and an end can be attached to the lower portion of the stationary plate 18 via a spring 21, which can secure the pawl 24 in upright position, keeping the pawl 24 engaged with the ratchet points 23. The pawl 24 can be depressed with manual force on a button 22 connected to its superior surface, causing the pawl 24 to pivot around the pivot point 20. This movement can stretch the spring 21 so that removal of the manual force on the button 22 allows the pawl 24 to lift upward to re-engage the ratchet points 23.

### EQUIVALENTS

Although preferred embodiments of the invention have been described using specific terms, such description is for illustrative purposes only, and it is to be understood that changes and variations may be made without departing from the spirit or scope of the following claims.

### INCORPORATION BY REFERENCE

The entire contents of all patents, published patent applications, and other references cited herein are hereby expressly incorporated herein in their entireties by reference.

1. A child vehicular safety seat comprising:
a seat back adapted and configured to support a child's back; and
a pommel extending substantially perpendicular from adjacent to the seat back, such that the child's perineum is supported by the pommel while the child's legs hang on either side of the pommel.

2. The child vehicular safety seat of claim 1, wherein the pommel is fixedly attached to the seat back.

3. The child vehicular safety seat of claim 1, further comprising:
a pair of adjustable supports, one on each side of the pommel.

4. The child vehicular safety seat of claim 3, wherein the pair of adjustable supports are movable substantially parallel to an axis defined by the pommel.

5. The child vehicular safety seat of claim 3, wherein the pair of adjustable supports are movable independently.

6. The child vehicular safety seat of claim 3, wherein the pair of adjustable supports are movable in tandem.

7. The child vehicular safety seat of claim 1, further comprising:
a pair of side-protection wings, each of the pair of side-protection wings coupled to an opposing side of the seat back.

8. The child vehicular safety seat of claim 7, wherein the pair of side-protection wings is rotatably coupled to the seat back.
